(19) United States
(12) Patent Application Publication
(10) Pub. No.: US 2023/0068747 A1
(43) Pub. Date: Mar. 2, 2023

(54) Quantum states generator

(71) Applicant: Daniel C. Smallwood, Cocoa Beach, FL (US)

(72) Inventor: Daniel C. Smallwood, Cocoa Beach, FL (US)

(21) Appl. No.: 17/896,494

(22) Filed: Aug. 26, 2022

Related U.S. Application Data
(60) Provisional application No. 63/237,365, filed on Aug. 26, 2021.

(51) Int. Cl. G06N 10/20

(52) U.S. Cl. CPC G06N 10/20

(57) ABSTRACT

In the present invention, there is provided a system to generate quantum states comprising a source of one or more wave-like particles that is/are input into one or more components and/or devices and/or subsystems that enable a superposition of paths that is/are linked to two or more oscillatory and/or resonant components, whereby the one or more wave-like particles initially possess, thereupon attain, or bring about the quality of quantum superposition of one or more degrees of freedom, and wherein the quantum superposition of the one or more degrees of freedom is obtained by each of the two or more oscillatory and/or resonant components.

### BACKGROUND OF THE INVENTION

The present invention generally relates to a system for generating a multitude of quantum states for use in quantum computation and/or quantum simulation and/or for transferring energy to one or more electrical loads. More particularly, the present invention relates to a system that effects a combination of various modes of quantum superposition, such as beam splitter-type which-way superposition and/or qubit-type intrinsic quantum states and/or optomechanical-type reactions and/or interactions, to occasion a significant quantitative increase in the total number of possible quantum states available to two or more oscillatory and/or resonant components.

Quantum superposition can occur when a particle comprising wave-particle duality, henceforth a wave-like particle, such as a photon, encounters a which-way interface, such as a beam splitter, which can reflect or transmit electromagnetic radiation in a manner according to Fresnel's equations. This causes the wave function of the wave-like particle to spread out in space with variable probability amplitudes in parallel, as corresponds to a which-way mode of superposition. Additionally, superposition of various quantum states intrinsic to wave-like particles, such as spin and/or polarization, is fundamental to quantum computation and quantum simulation.

Another type of quantum superposition can occur in quantum optomechanics, wherein a wave function comprising for example, one or more bosons, such as a photon or photons, exerts a gas-like and/or a radiation and/or a radiation-like pressure on the boundaries of an optical cavity that can be used to displace and/or deform a mechanical component, such as a membrane. The displacement and/or deformation of the mechanical component is proportional to various parameters such as the amplitude and/or the frequency of the one or more photons resident in the optical cavity, the finesse and/or the mode volume of the optical cavity, a frequency differential and/or the detuning between the one or more photons and the mechanical component, and additional parameters related to decoherence time such as the mechanical quality factor and the temperature of the optomechanical components, all of which are related to the optomechanical coupling strength. Entanglement-like and/or beam splitter-like interactions can occur between the photons and the mechanical component (e.g., phonons), wherein with a suitably designed system, an uncertainty in the position of the center of mass of the mechanical component can occur.

Qubit systems scale exponentially according to 2ⁿ, where n is the number qubits, which is due to a binary superposition in the measurement basis. Specifically, for a wave-like particle such as an electron, the spin states superposition for one particle is described by |Ψ [symbol] =α|↑ [symbol] 'β|↓), as corresponds to 2¹, and for two electrons |Ψ [symbol] =α|↑↑ [symbol] +β|↑↓ [symbol] +γ|↓↑ [symbol] +δ|↓↓ [symbol] , as corresponds to 2². Designing and implementing controllable, coherent quantum systems with relatively long decoherence times and a maximum number of entangled quantum states has become a cornerstone objective of modern quantum computation and quantum simulation research. Therein, the number of quantum states available to a quantum system can be increased by adding to the number of particles, n, wherein the exponential base, 2, is limited by the binary nature of the pure quantum states associated with each wave-like particle along the measurement basis. Correspondingly, each quantum particle provides two quantum states to the system of interest. In the present invention, a novel system is described that enables one or more quantum particles to provide a multitude of quantum states (e.g., two or more) for the system of interest that scales according to (2*(m+1))ⁿ, m corresponding to a number of beam-splitters or beam-splitter type interactions, wherein the advantage arises from the combination of various modes of quantum superposition throughout the system. Furthermore, the classical Carnot limit could be surpassed for a quantum engine that extracts work by utilizing unitary transformations on non-classical states such as coherent and/or squeezed quantum states, whereby these states can be prepared in an optical cavity. Additionally, herein provided are several embodiments that utilize the quantum states scaling advantage of the present invention with one or more means of transduction, comprising for example, two or more optomechanical cavities to generate for example, a multitude of coherent and/or squeezed quantum states that could, as herein described in at least one embodiment of the present invention, be used to transfer energy in a highly efficient manner to one or more electrical loads.

### BRIEF SUMMARY OF THE INVENTION

In one aspect of the invention, there is provided a system to generate quantum states comprising a source of one or more wave-like particles that is/are input into one or more components and/or devices and/or subsystems that enable a superposition of paths, such as a beam splitter or beam splitters, that is/are linked to two or more oscillatory and/or resonant components, whereby the one or more wave-like particles initially possess, thereupon attain, or bring about the quality of quantum superposition of one or more degrees of freedom, and wherein the quantum superposition of the one or more degrees of freedom is obtained by each of the two or more oscillatory and/or resonant components.

In one embodiment, the two or more oscillatory and/or resonant components are each linked to an integer number (e.g., 0, 1, . . . , n) of additional systems, wherein the integer number of additional systems each comprise an integer number of wave-like particles that is/are input into an integer number of components and/or devices and/or subsystems that enable a superposition of paths that is/are linked to an integer number of oscillatory and/or resonant components, whereby the integer number of wave-like particles in each of the integer number of additional systems initially possess, thereupon attain, or bring about the quality of quantum superposition of one or more degrees of freedom, and wherein the quantum superposition of the one or more degrees of freedom is obtained by each of the integer number of oscillatory and/or resonant components.

In one embodiment, the two or more oscillatory and/or resonant components each comprise components of and/or circuitry for quantum computation and/or quantum simulation.

In one embodiment, the two or more oscillatory and/or resonant components may be interconnected by any suitable means.

In one embodiment, one or more of the two or more oscillatory and/or resonant components comprises a cavity.

In one embodiment, one or more of the one or more cavities comprises or is adjacent to a means of transduction, and wherein each means of transduction is linked to or comprises a component of and/or circuitry for quantum computation and/or quantum simulation and/or one or more electrical loads.

In one embodiment, each of the one or more cavities that comprises or is adjacent to a means of transduction further comprises one or more surfaces and/or elements that reflect photons and/or rebound matter-waves and/or function as a waveguide, wherein at least one of the one or more surfaces and/or elements that reflect photons and/or rebound matter-waves and/or function as a waveguide possess one or more mechanical degrees of freedom and is/are thereby permitted to react to and/or interact with a radiation or radiation-like pressure of the one or more wave-like particles, thereby enabling movement and/or deformation and/or one or more coherent states and/or one or more squeezed states of the one or more surfaces and/or elements that possess one or more mechanical degrees of freedom.

In one embodiment, one or more of the one or more surfaces and/or elements that is/are permitted to react to and/or interact with a radiation or radiation-like pressure is/are adjacent to or comprise the first part of a capacitor, wherein the first part of each capacitor is linked to a second part of each capacitor, and wherein the first and/or second parts of each capacitor is/are linked to a conductive material.

In one embodiment, one or more of the one or more surfaces and/or elements that is/are permitted to react to and/or interact with a radiation or radiation-like pressure is/are adjacent to or comprise a magnetic material that is further adjacent to, surrounded by, or otherwise linked to a conductive material, such as coil in the manner of a solenoid, wherein the magnetic material comprises the terminus of or is external to the cavity.

In one embodiment, the conductive material extends from the region of the two or more cavities in a parallel format, thereby creating a which-way conductive mode of superposition, wherein an electrical current can arise in the conductive material due to, for example, electromagnetic induction or changes in capacitance due to an uncertainty in the center of mass of the first part of each capacitor.

In one embodiment, information about the which-way conductive mode is erased or made inaccessible prior to interaction with a component of and/or circuitry for quantum computation and/or quantum simulation and/or one or more electrical loads by any suitable means.

In one embodiment, the source is pulsed, thereby enabling a periodicity of the modes of superposition and/or providing amplification and/or damping effects.

In one embodiment, the source is pulsed at a rate equal to or greater than the resonant frequency of the one or more surfaces that reflect photons and/or rebound matter-waves and/or function as a waveguide, wherein a phase offset may be used, thereby enabling a periodicity of the modes of superposition and/or providing amplification and/or damping effects.

In one embodiment, at least one of the one or more surfaces in each of the two or more cavities that reflects photons and/or rebounds matter-waves and/or function as a waveguide is/are adjacent to a chamber filled with a compressible fluid, such as a gas, that functions in the manner of a piston, wherein the adjacent fluid substitutes the conductive material and is external to the cavity, whereby the compression of the fluid is used to actuate one or more mechanical components, which therein substitutes, but may otherwise eventually lead to a component of and/or circuitry for quantum computation and/or quantum simulation and/or one or more electrical loads.

In one embodiment, the system is provided in and/or on a substrate comprising a semiconductor and/or a doped semiconductor and/or a glass and/or a ceramic and/or PCB and/or a plastic.

In one embodiment, the system or parts of the system are microscopic and/or mesoscopic and/or macroscopic.

In one embodiment, the system or parts of the system comprise/s a MEMS and/or a NEMS device.

In one embodiment, cryogenic temperatures and/or a vacuum and/or microgravity are utilized to enable and/or prolong the modes of superposition.

In one embodiment, the one or more wave-like particles comprise a photon or photons, a matter-wave or matter-waves and/or a Bose-Einstein condensate.

In one embodiment, the two or more oscillatory and/or resonant components comprise atoms and/or artificial atoms and/or ions and/or one or more types of quasiparticles such as magnons and/or phonons and/or any suitable oscillatory and/or resonant components.

In one embodiment, the two or more oscillatory and/or resonant components comprise part of or the whole of one or more inductor-capacitor (LC) circuits, wherein one or more Josephson junction/s (JJs) and/or shunted JJs (e.g., transmon qubit/s) comprise the inductor element, and wherein one or more measurable parameters such as an oscillating and/or a resonant frequency of the LC circuit is/are affected by one or more of the hereinbefore described systems of the present invention.

In one embodiment, the one or more cavities have a high finesse.

In one embodiment, the one or more cavities comprise, whether in total or in part, one or more Bragg mirrors and/or cantilevers and/or photonic crystals and/or elastic membranes and/or piezoelectric materials.

In one embodiment, the one or more cavities comprise whispering gallery modes, wherein various topologies such as circular, cylindrical, spherical, linear and toroidal may be used.

In one embodiment, strong optomechanical coupling and/or a high mechanical quality factor and/or parametric amplification and/or detuning and/or squeezed states and/or the Casimir effect is/are utilized.

In one embodiment, the cooling and/or heating mechanism is optomechanical.

In one embodiment, the conductive material comprises a superconductor and/or carbon nanotubes and/or a plasma and/or a conductive material such as silver, copper, gold or aluminum.

In one embodiment, information about the which-way conductive mode is erased or made inaccessible prior to interaction with a component of and/or circuitry for quantum computation and/or quantum simulation and/or one or more electrical loads by utilizing various indices of refraction and/or material thicknesses and/or flight times and/or cavity residence times and/or conductive material lengths and/or utilizing one or more diodes and/or spark gaps and/or capacitors and/or switching elements, such as one or more transistors.

### BRIEF DESCRIPTION OF THE SEVERAL VIEWS OF THE DRAWING

The following description of embodiments herein supplements comprehension of the present invention, is provided by way of example only, and references the accompanying drawings, wherein:

FIG. 1 depicts one embodiment of the system of the present invention;

FIG. 2 provides a flowchart corresponding to the embodiment depicted in FIG. 1;

FIG. 3 depicts another embodiment of the system of the present invention;

FIG. 4 provides a flowchart corresponding to the embodiment depicted in FIG. 3;

FIG. 5 graphically demonstrates a quantitative utility of the system depicted in FIG. 3 and FIG. 4;

FIG. 6 depicts one embodiment of the system of the present invention;

FIG. 7 depicts another embodiment of the system of the present invention;

FIG. 8A depicts a first alternative embodiment of the conductive link to an electrical load;

FIG. 8B depicts a second alternative embodiment of the conductive link to an electrical load; and

FIG. 8C depicts a third alternative embodiment of the conductive link to an electrical load.

### DETAILED DESCRIPTION OF THE INVENTION

The following detailed description of embodiments herein supplements comprehension of the present invention, is provided by way of example only, and references the accompanying drawings, wherein:

In the present invention, there is provided a system to generate quantum states comprising a source of one or more wave-like particles that is/are input into one or more components and/or devices and/or subsystems that enable a superposition of paths, such as a beam splitter or beam splitters, that is/are linked to two or more oscillatory and/or resonant components, whereby the one or more wave-like particles initially possess, thereupon attain, or bring about the quality of quantum superposition of one or more degrees of freedom, and wherein the quantum superposition of the one or more degrees of freedom is obtained by each of the two or more oscillatory and/or resonant components.

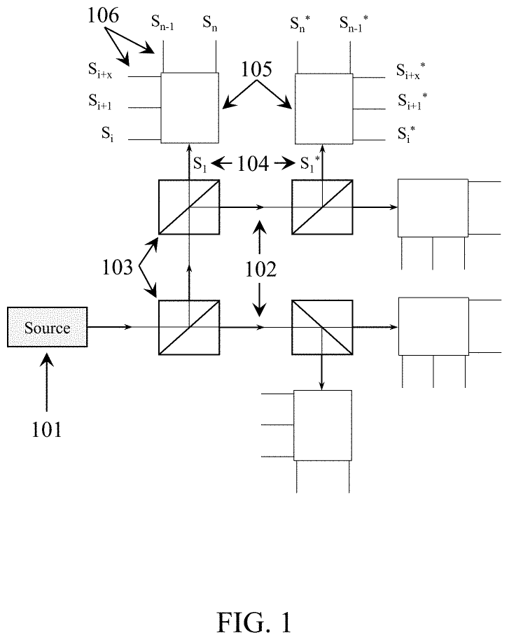

FIG. 1 depicts one embodiment of the system of the present invention. In this embodiment, the system comprises a source 101 of one or more wave-like particles 102 that is/are input into one or more components and/or devices and/or subsystems that enable a superposition of paths, such as a beam splitter or beam splitters 103. A quantum superposition of one or more degrees of freedom arising from this first system (e.g., S₁) 104, is obtained by each of the two or more oscillatory and/or resonant components 105, which may be linked to one or more additional systems, each possessing a quantum superposition of one or more degrees of freedom (e.g., S₁, S₁₊₁, . . . , Sₙ₋₁, Sₙ) 106 that may or may not be similar to S₁. It will be appreciated that the quantum state of each of the oscillatory and/or resonant components 105 is comprised of the quantum states of the connected systems (e.g., S₁-Sₙ), and that the quantum states S₁-Sₙ may or may not be similar to the quantum states depicted in parallel S₁*-Sₙ*. It can be understood that the quantum state coefficients due to the wave-like particle/s 102 are a function of and can be tailored by the number of and the manner of the beam splitters 103, which corresponds to the quantum state coefficients of each of the oscillatory and/or resonant components 105, wherein the oscillatory and/or resonant components 105 can comprise components of and/or circuitry for quantum computation and/or quantum simulation. Additionally, the oscillatory and/or resonant components 105 may be selectively interconnected by any suitable means.

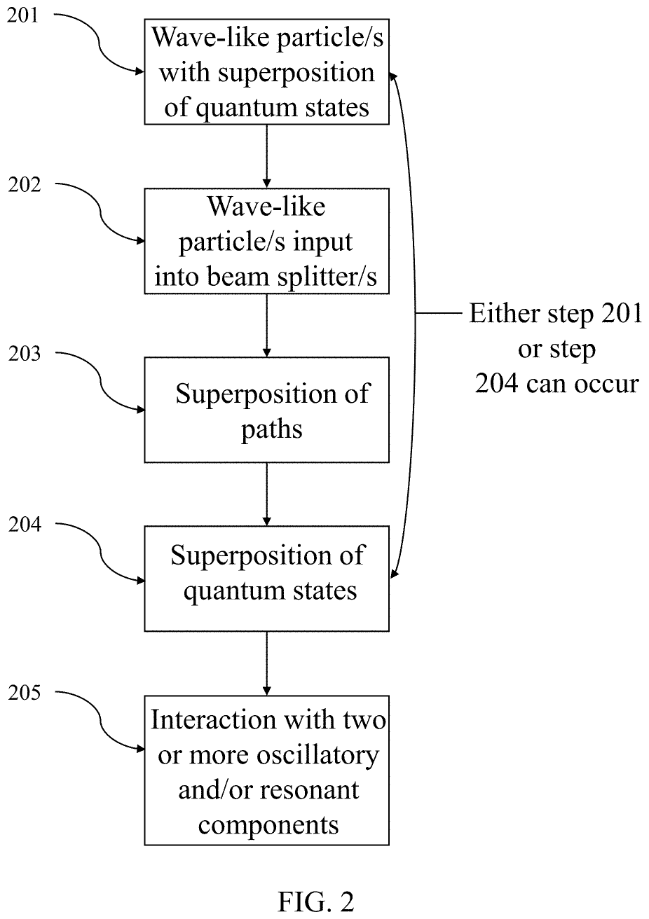

FIG. 2 provides a flowchart corresponding to the embodiment depicted in FIG. 1. In step 201, the one or more wave-like particle/s 102 initially possess the quality of quantum superposition of one or more degrees of freedom. In step 202, the one or more wave-like particles are input into one or more components and/or devices and/or subsystems that enable a superposition of paths, such as a beam splitter or beam splitters 103. In step 203, the one or more wave-like particles undergo a superposition of paths. In step 204, the one or more wave-like particles attain or bring about the quality of quantum superposition of one or more degrees of freedom, wherein either step 201 or step 204 can occur. In step 205, the one or more wave-like particles that initially possessed, thereupon attained, or brought about the quality of quantum superposition of one or more degrees of freedom 104 interact with two or more oscillatory and/or resonant components 105.

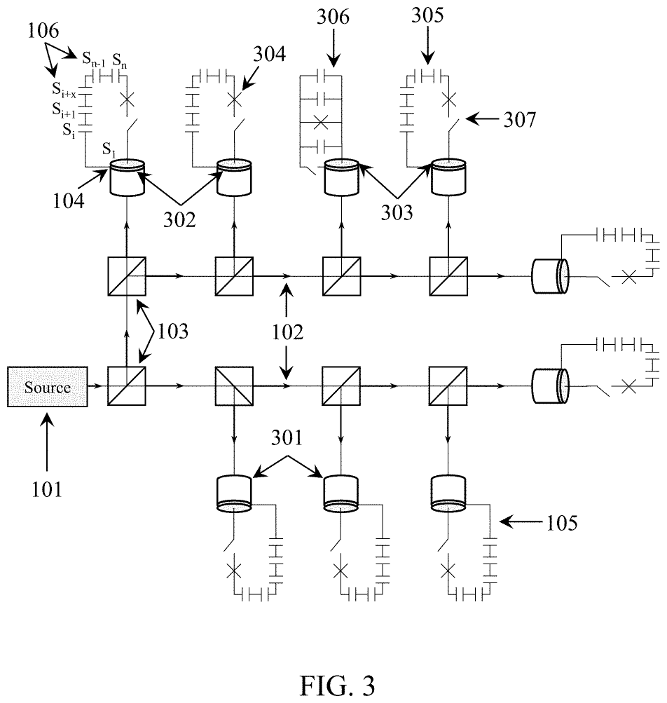

FIG. 3 depicts another embodiment of the system of the present invention. In this embodiment, the system comprises a source 101 of one or more wave-like particles 102 and one or more components and/or devices and/or subsystems that enable a superposition of paths, such as a beam splitter or beam splitters 103 that is/are linked to two or more cavities 301. The two or more cavities 301 each comprise a movable reflector or a surface that rebounds matter-waves 302, which further comprises or is adjacent to the first plate of a capacitor 302, that is linked to the second plate of a capacitor 303. The one or more wave-like particles 102 bring about the quality of quantum superposition of the first plate of the capacitor 302, as corresponds to movement and/or deformation and/or one or more coherent states and/or one or more squeezed states, which could be affected by for example, optomechanical coupling. The first 302 and second 303 plates of the capacitor further comprise an element of a superconducting inductor-capacitor (LC) circuit, as corresponds to the two or more oscillatory and/or resonant components 105, wherein the depicted circuit element 304 comprises one or more Josephson junction/s and/or transmon qubit/s. The two or more oscillatory and/or resonant components 105 may be linked to one or more additional systems, each possessing a quantum superposition of one or more degrees of freedom (e.g., S₁, Sᵢ₊₁ . . . Sₙ₋₁, Sₙ) 106 that may or may not be similar to S₁, wherein the systems S₁-Sₙ could be arranged in series 305 or in parallel 306, and wherein the switch 307 could be used to toggle various on/off states of the oscillatory and/or resonant components 105. Additionally, the oscillatory and/or resonant components 105 may be selectively interconnected by any suitable means, such as with additional capacitors.

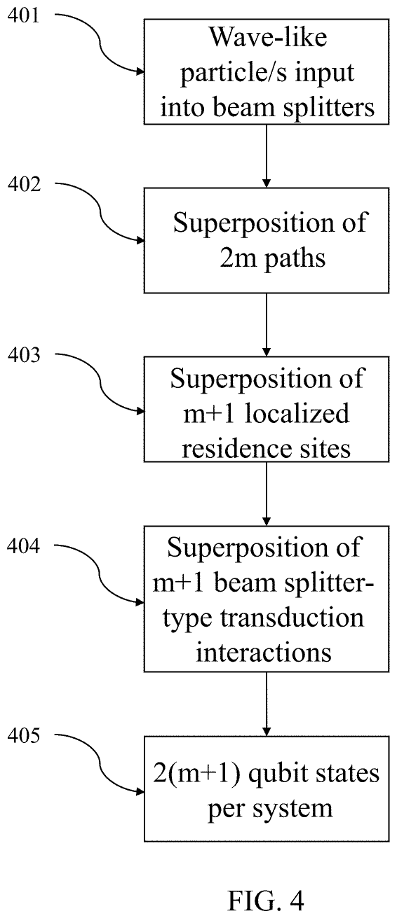

FIG. 4 provides a flowchart corresponding to the embodiment depicted in FIG. 3. In step 401, one or more wave-like particles 102 are input into one or more one or more components and/or devices and/or subsystems that enable a superposition of paths, such as a beam splitter or beam splitters 103. In step 402, the one or more wave-like particles are placed into a superposition of 2 m paths, where m corresponds to the number of beam splitters 103. In step 403, the one or more wave-like particles are placed into superposition at m+1 localized residence sites, as corresponds to the cavity elements 301. In step 404, the one or more wave-like particles in superposition at the m+1 localized residence sites participate in a superposition of m+1 beam splitter-type transduction interactions, which could be affected by for example, optomechanical coupling that transfers a phonon or phonons to the first plate of a capacitor 302. In step 405, the superposition of m+1 beam splitter-type transduction interactions affects 2(m+1) quantum states per system Sᵢ, I=1, 2, . . . , n, whereby the total number of quantum states for n systems is (2(m+1))ⁿ when assuming m is constant across all systems Sᵢ, although this is not a requirement of this embodiment or any of the embodiments herein described.

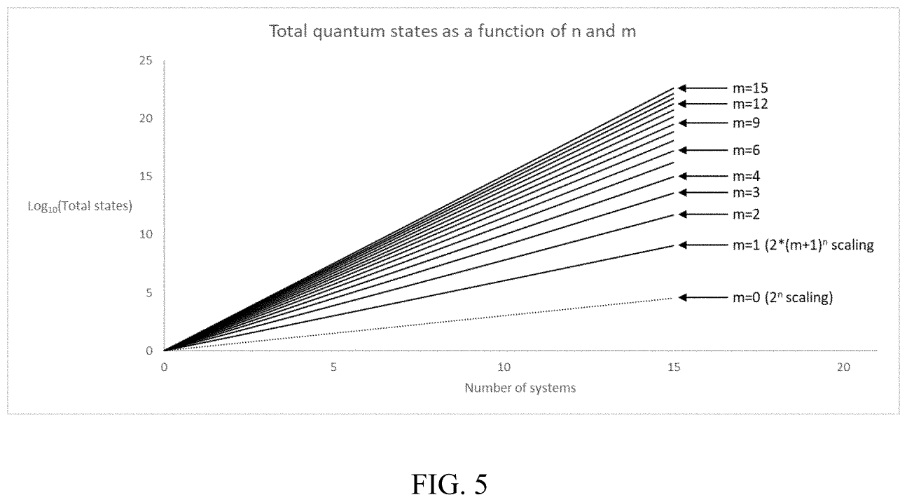

FIG. 5 graphically demonstrates a quantitative utility of the quantum states generator of the present invention, as depicted in the embodiment of FIG. 3 and as discussed in the embodiment of FIG. 4. The abscissa is the number of n systems, n=0, 1, . . . , 15 and the ordinate is log₁₀ of the total number of quantum states (2(m+1))ⁿ, wherein each line corresponds to a separate m, m=0, 1, . . . , 15. Note that when m=0 this equation reduces to 2ⁿ.

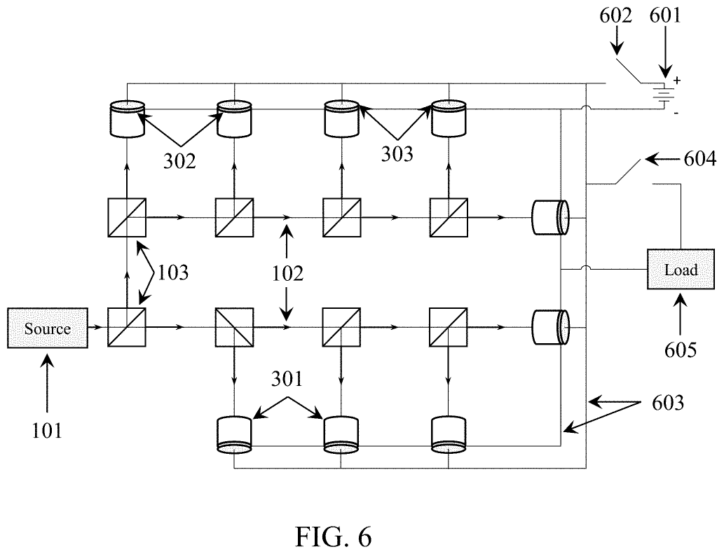

FIG. 6 depicts another embodiment of the system of the present invention. In this embodiment, the system comprises a source 101 that inputs one or more wave-like particles 102 into an array of components and/or devices and/or subsystems that enable a superposition of paths, such as a beam splitter or beam splitters 103 that are linked to an array of cavities 301. It will be appreciated that any number of sources 101, beam splitters 103, cavities 301 and loads 605 can be used in this and any other embodiment of the present invention, wherein the source 101 and the beam splitters 103 may provide output angles other than shown, each beam splitter 103 may provide one or more outputs, the wave-like particles 102 may comprise a photon or photons, a matter-wave or matter-waves, or a Bose-Einstein condensate, and the source 101 may be pulsed. In this embodiment, the system comprises an array of cavities 301 that each comprise photon reflectors or surfaces that rebound matter-waves, wherein the cavities further comprise a movable reflector or a surface that rebounds matter-waves 302, which comprises or is adjacent to the first plate of a capacitor 302, that is linked to the second plate of a capacitor 303, wherein any number of thin films and/or materials may comprise or be provided between elements 302 and 303. It will be appreciated that in this and any other embodiment of the present invention, any number of cavities 301, sources of electrical energy 601, and switches 602 and 604 can be used, and the cavity 301 input number may be greater than one and may occur at angles other than shown, and there may be one or more movable reflectors or surfaces 302 in each cavity 301 that each comprise one or more mechanical degrees of freedom, which could also take the form whispering gallery modes or deformations of a piezoelectric material. The first and second plates 302 and 303 of each capacitor are connected to one or more tracks of conductive material 603, that are selectively connected to a source of electrical energy 601. The source of electrical energy 601 can be used to charge the first and second plates 302 and 303 of each capacitor, and can be disconnected from the one or more tracks of conductive material 603 by a first switch 602. A second switch 604 can be used to cycle the connection between the tracks of conductive material 603 and an electrical load 605, wherein the tracks of conductive material 603 provide a means to conduct electricity from each capacitor comprising elements 302 and 303 to an electrical load 605. Although depicted as a pole, the switches in this and any other embodiment of the present invention may comprise a transistor or any other suitable switch, and the use of a source of electrical energy 601 and the first and second switches 602 and 604 is optional and may be circumvented by any other suitable means to charge and/or activate the one or more capacitors.

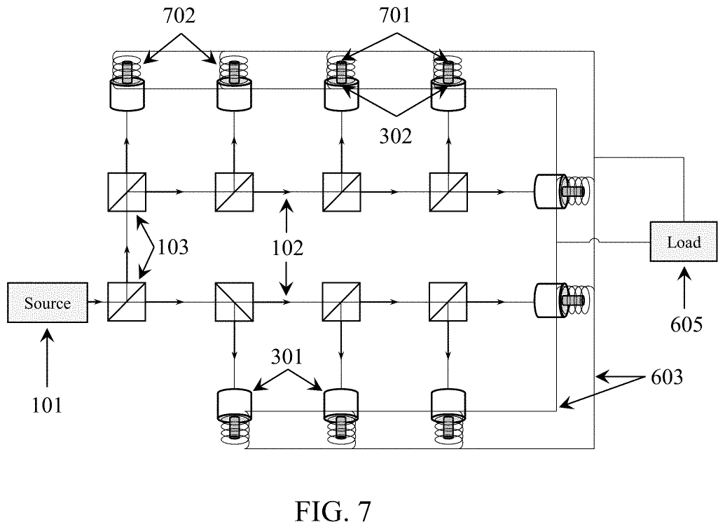

FIG. 7 depicts another embodiment of the system of the present invention, which comprises elements 101-103, 603 and 605, as hereinbefore described. In this embodiment, each cavity 301 comprises at least two distinct photon reflectors or surfaces that rebound matter-waves, wherein each cavity further comprises a movable reflector or a surface that rebounds matter-waves 302, which is adjacent to a magnetic material 701, such as a ferromagnetic material (e.g., hard or soft) or a paramagnetic material or any other suitable magnetic material, wherein any number of thin films and/or materials may be provided between elements 302 and 701. In this and any other embodiment of the present invention, the cavity 301 input number may be greater than one and may occur at angles other than shown, and there may be one or more movable mirrors or surfaces 302 in each cavity 301 that each comprise one or more mechanical degrees of freedom. The hard magnetic material 701 is linked to a coil of conductive material 702, which is connected to one or more tracks of conductive material 603, that are connected to an electrical load 605, wherein the tracks of conductive material 603 provide a means to conduct electricity from the coil of conductive material 702 to an electrical load 605. In alternative embodiments, the coil of conductive material 702 comprises a solid or a mesh cylinder. In this and any other embodiment of the present invention, the conductive materials comprise a superconductor and/or carbon nanotubes and/or plasma and/or a standard conductive material such as silver, copper, gold or aluminum.

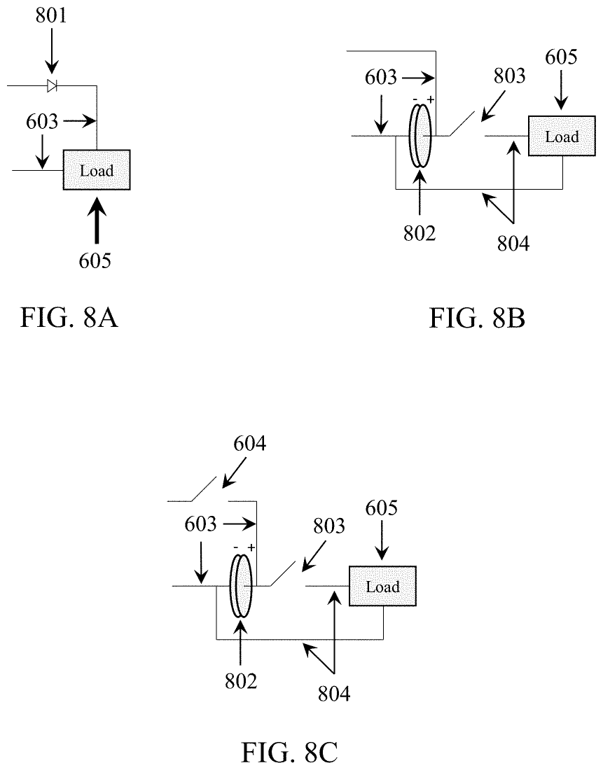

FIG. 8 depicts three alternative embodiments of the conductive link to an electrical load, wherein any of the depicted elements may be integrated with the embodiments as depicted in FIG. 6 and FIG. 7, or any of the embodiments hereinbefore described. In the embodiment of FIG. 8A, the terminal link comprises a forward biased diode 801, which conducts electricity after a threshold voltage has been surpassed. In the embodiment of FIG. 8B, the terminal link comprises a capacitor 802 that is charged via the tracks of conductive material 603, whereupon a switch 803 can be used to establish a conductive link with an electrical load 605 via the conductive tracks 804. In the embodiment of FIG. 8C, the terminal link comprises a capacitor 802 which can be disconnected from the electrical tracks 603 by a first switch 604, whereupon the elements 803 and 804 perform as hereinbefore described.

In the embodiments heretofore described, maintaining the linked modes of superposition is important for the quantum states generator of the present invention. Thus, in the embodiments depicted in FIG. 8A, FIG. 8B and FIG. 8C, the terminal links aim to make information regarding the which-way conductive mode of superposition inaccessible, which can be further aided by cooling the generator or parts of the generator and/or utilizing a vacuum and/or utilizing superconducting material. It will be appreciated that in these and any other embodiments of the present invention, any number of elements 801, 802, 803 and 804 may be used, the use of switches 604 and 803 is optional, and the depicted elements can be substituted and/or modified by any suitable components and/or means, such as utilizing various indices of refraction and/or material thicknesses and/or flight times and/or cavity residence times and/or conductive material lengths and/or utilizing one or more diodes and/or spark gaps and/or capacitors and/or switches, such as a transistor or transistors.

In the specification, the terms “comprise, comprises, comprised and comprising” or any variation thereof and the terms “include, includes, included and including” or any variation thereof and the terms “link, links, linked and linking” or any variation thereof are considered to be totally interchangeable and they should all be afforded the widest possible interpretation and vice versa. Although embodiments of the present invention have been shown and described, it will be appreciated by those skilled in the art that changes, modifications, substitutions and alterations can be made in these embodiments without departing from the principles and spirit of the invention, the scope of which is defined in the claims and their equivalents.

1. A system for generating quantum states comprising:
a source of one or more wave-like particles that is/are input into one or more components and/or devices and/or subsystems that enable a superposition of paths that is/are linked to two or more oscillatory and/or resonant components, whereby the one or more wave-like particles initially possess, thereupon attain, or bring about the quality of quantum superposition of one or more degrees of freedom, and wherein the quantum superposition of the one or more degrees of freedom is obtained by each of the two or more oscillatory and/or resonant components.

2. The system of claim 1, wherein the two or more oscillatory and/or resonant components are each linked to an integer number of additional systems, wherein the integer number of additional systems each comprise an integer number of wave-like particles that is/are input into an integer number of components and/or devices and/or subsystems that enable a superposition of paths that is/are linked to an integer number of oscillatory and/or resonant components, whereby the integer number of wave-like particles in each of the integer number of additional systems initially possess, thereupon attain, or bring about the quality of quantum superposition of one or more degrees of freedom, and wherein the quantum superposition of the one or more degrees of freedom is obtained by each of the integer number of oscillatory and/or resonant components.

3. The system of claim 2, wherein the two or more oscillatory and/or resonant components each comprise components of and/or circuitry for quantum computation and/or quantum simulation.

4. The system of claim 3, wherein the two or more oscillatory and/or resonant components may be interconnected.

5. The system of claim 2, wherein one or more of the two or more oscillatory and/or resonant components comprises a cavity.

6. The system of claim 5, wherein one or more of the one or more cavities comprises or is adjacent to a means of transduction, and wherein each means of transduction is linked to or comprises a component of and/or circuitry for quantum computation and/or quantum simulation and/or one or more electrical loads.

7. The system of claim 6, wherein each of the one or more cavities that comprises or is adjacent to a means of transduction further comprises one or more surfaces and/or elements that reflect photons and/or rebound matter-waves and/or function as a waveguide, wherein at least one of the one or more surfaces and/or elements that reflect photons and/or rebound matter-waves and/or function as a waveguide possess one or more mechanical degrees of freedom and is/are thereby permitted to react to and/or interact with a radiation or radiation-like pressure due to the one or more wave-like particles, thereby enabling movement and/or deformation and/or one or more coherent states and/or one or more squeezed states of the one or more surfaces and/or elements that possess one or more mechanical degrees of freedom.

8. The system of claim 7, wherein one or more of the one or more surfaces and/or elements that is/are permitted to react to and/or interact with a radiation or radiation-like pressure is/are adjacent to or comprise the first part of a capacitor, wherein the first part of each capacitor is linked to a second part of each capacitor, and wherein the first and/or second parts of each capacitor is/are linked to a conductive material.

9. The system of claim 7, wherein one or more of the one or more surfaces and/or elements that is/are permitted to react to and/or interact with a radiation or radiation-like pressure is/are adjacent to or comprise a magnetic material that is further adjacent to, surrounded by, or otherwise linked to a conductive material.
